(19) United States
(12) Patent Application Publication
(10) Pub. No.: US 2018/0016968 A1
(43) Pub. Date: Jan. 18, 2018

(54) Two-Stage Exhaust-Gas Turbocharging Device for an Internal Combustion Engine

(71) Applicant: Bayerische Motoren Werke Aktiengesellschaft, Muenchen (DE)

(72) Inventors: Stefan Leopold ABLINGER, Steyr (AT); Gerald GRUBER, Nussdorf (AT)

(21) Appl. No.: 15/663,225

(22) Filed: Jul. 28, 2017

Related U.S. Application Data
(63) Continuation of application No. PCT/EP2016/051272, filed on Jan. 22, 2016.

(30) Foreign Application Priority Data
Mar. 2, 2015 (DE) 10 2015 203 621.9

(51) Int. Cl. F02B 37/00; F02B 37/16; F02B 37/013; F02B 37/007; F02B 37/24; F02B 37/18

(52) U.S. Cl. CPC F02B 37/001; F02B 37/24; F02B 37/18; F02B 37/004; F02B 37/013; F02B 37/007; F02B 37/16

(57) ABSTRACT

A two-stage exhaust gas turbocharging device for an internal combustion engine includes a high-pressure stage, and a low-pressure stage. The high-pressure stage and the low-pressure stage are connected via exhaust-gas lines and fresh-air lines in a gas-conducting manner. An exhaust gas of the internal combustion engine can flow first through the high-pressure turbines and then the low-pressure turbines and wherein fresh air are conveyable first through the low-pressure compressors and then through the high-pressure compressors in the direction of the internal combustion engine. The high-pressure turbines are connected to the low-pressure turbines at least in sections via a common exhaust-gas line and the low-pressure compressors to the high-pressure compressors at least in sections via a common fresh-air line.

### CROSS REFERENCE TO RELATED APPLICATIONS

This application is a continuation of PCT International Application No. PCT/EP2016/051272, filed Jan. 22, 2016, which claims priority under 35 U.S.C. §119 from German Patent Application No. 10 2015 203 621.9, filed Mar. 2, 2015, the entire disclosures of which are herein expressly incorporated by reference.

### BACKGROUND AND SUMMARY OF THE INVENTION

Embodiments of the invention relate to a two-stage exhaust-gas turbocharging device for an internal combustion engine.

Regarding the technical environment, reference is made for example to the German disclosure publication DE 10 2006 011 188 A1. From this disclosure publication, a two-stage exhaust-gas turbocharging device for an internal combustion engine with an exhaust manifold is known. Here, in the flow direction of the exhaust gas of the internal combustion engine, the exhaust-gas turbocharging device comprises a first and a second high-pressure turbocharger arranged parallel to one another and a low-pressure turbocharger arranged in series thereafter. Here, the exhaust manifold and the first high-pressure turbine of the first high-pressure turbocharger and the low-pressure turbine of the low-pressure turbocharger are connected to one another in an exhaust gas conducting manner. Furthermore, the exhaust manifold is connectable to a second high-pressure turbine of the second high-pressure turbocharger in an exhaust gas conducting manner. According to the invention it is proposed that the second high-pressure turbine and the low-pressure turbine are connected to one another in an exhaust gas conducting manner.

With this configuration, a high efficiency with acceptable structural expenditure of the two-stage exhaust-gas turbocharging device is achieved.

The permanent two-stage turbocharging makes possible a significant increase of the overall pressure ratio and thus of the charge pressure of the internal combustion engine. Stationarily, the mean pressure of the internal combustion engine can thereby be significantly increased throughout the entire rotational speed range. The entire air and exhaust gas mass flow of the internal combustion engine flows through the low-pressure stage as a result of which a particularly large mass flow range has to be taken into account in the thermodynamic design of the exhaust gas turbocharger. With the size of the exhaust gas turbocharger, in particular of the low-pressure turbocharger, the mass moment of inertia of the running gear grows, which in turn significantly worsens the dynamic run-up during the acceleration of a vehicle.

Even if this known prior art does not have any serious disadvantages it is desirable to further improve the response behavior of the internal combustion engine with the multi-stage turbocharging, wherein transitions between different operating ranges should be designable even more harmonically.

A possibility of further improving the response behavior of an internal combustion engine with multi-stage turbocharging is known for example from the German patent publication DE 36 07 698 C1. From this patent publication, a piston-type internal combustion engine with two-stage turbocharging is known. Two exhaust gas turbocharger groups, each consisting of high-pressure and low-pressure exhaust gas turbochargers, supply the piston-type internal combustion engine with charge air. The one exhaust gas turbocharger group is designed to be activatable and deactivatable, in each case a shut-off device is arranged in the exhaust-gas line of the high-pressure exhaust gas turbocharger and in the suction lines of the low-pressure exhaust gas turbocharger. For activating and deactivating an exhaust gas turbocharger group at part load of the piston-type internal combustion engine, the passage cross sections of both shut-off devices are controlled. In order to avoid impermissible overspeeds on the running gear of an exhaust gas turbocharger upon activation, charge air from the pressure side is recirculated to the suction side via a controllable bypass line, which is arranged between the suction and pressure line of the high-pressure compressor.

By way of a shut-off device, the bypass line is controlled as a function of the opening of the charge air shut-off device. Deactivating exhaust gas turbocharger groups in the case of piston-type internal combustion engines is carried out for increasing charge air pressure and charge air quantity with, compared with full load operation, reduced accrual of exhaust gas energy than in part load and in part rotational speed range of the piston-type internal combustion engine. Here, only one exhaust gas turbocharger group operates with low exhaust gas energy accrual. When the performance of the piston-type internal combustion engine increases, one or more exhaust gas turbocharger groups are gradually activated in parallel until finally at full load operation all existing exhaust gas turbocharger groups operate.

Furthermore, a turbocharged piston-type internal combustion engine with a plurality of exhaust gas turbocharger groups operating in parallel is likewise known from the international patent application with the international patent application number WO 90/01112.

During the non-stationary run-up of internal combustion engines, the dynamic behavior of the turbocharging system is of particular importance. Particularly in the case of turbocharging systems with more than one exhaust gas turbocharger, the transitions between operating ranges constitute a particular challenge. These should be negotiated as quickly as possible and without a drop in the charge air mass flow build-up.

One of the objects of the present invention is to realize a dynamic improvement of the two-stage exhaust-gas turbocharging relative to the prior art, without a drop in the charge air mass flow build-up between different operating ranges.

By splitting the one low-pressure stage, as described in DE 10 2006 011 188 A1, into two low-pressure stages or two low-pressure exhaust gas turbochargers, which are arranged parallel next to one another and not combined into exhaust gas turbocharger groups, as described in DE 36 07 698 C1, the dynamic run-up behavior and thus the acceleration capability of a motor vehicle can be significantly improved. The dynamic run-up behavior of the low-pressure exhaust gas turbocharger can be significantly improved through lower or divided mass moments of inertia of the running gear. The acceleration capability is substantially improved from the stationary state and in low gears.

Since a high-pressure exhaust gas turbocharger is embodied preferentially switchable, the present turbocharging system is characterized by two operating ranges. Through the permanent operation of the two low-pressure exhaust gas turbochargers the dynamic run-up behavior and the transition between these two operating ranges are significantly improved compared with the prior art.

Through the parallel operation of the two low-pressure exhaust gas turbochargers, a common charge air cooler between low and high-pressure compressors can be used. Through this simplification, the overall system can be realized more compactly and significantly more cost-effectively.

Through the permanent operation of the two low-pressure exhaust gas turbochargers, the regulation of the turbocharging system is significantly improved, furthermore, since in particular at the transition between the operating ranges the low-pressure exhaust gas turbochargers are continuously active and are thus available for the regulation of the fresh air and exhaust gas mass flows. Because of this, a drop in the charge air mass flow build-up can be almost completely prevented.

The configurations presented herein advantageously offer a structural simplification and reduction in size of the exhaust gas turbocharging device, with simultaneous reduction of the manufacturing costs. Additionally, with the configurations presented herein, defined charge air mass flows can be adjusted so that a largely stepless acceleration of a vehicle is possible. Moreover, with the configurations presented herein, over-revving of a running gear or of a turbine wheel can be counteracted. Additionally, with the configurations presented herein, the efficiency of the multi-stage exhaust gas turbocharging device can once again be substantially improved. Further, with the configurations presented herein, an even more uniform regulation of the multi-stage exhaust gas turbocharging device is possible. Additionally, with the configurations presented herein, over-revving of a running gear or of a compressor wheel can be counteracted.

Other objects, advantages and novel features of the embodiments of the present invention will become apparent from the following detailed description of one or more preferred embodiments when considered in conjunction with the accompanying drawings, in which:

### BRIEF DESCRIPTION OF THE DRAWINGS

FIG. 1 is a schematical construction of a two-stage exhaust gas turbocharging device for an internal combustion engine; and

FIG. 2 is a diagram depicting the technical effect of the inventive two-stage exhaust gas turbocharging device compared with the prior art.

### DETAILED DESCRIPTION OF THE DRAWINGS

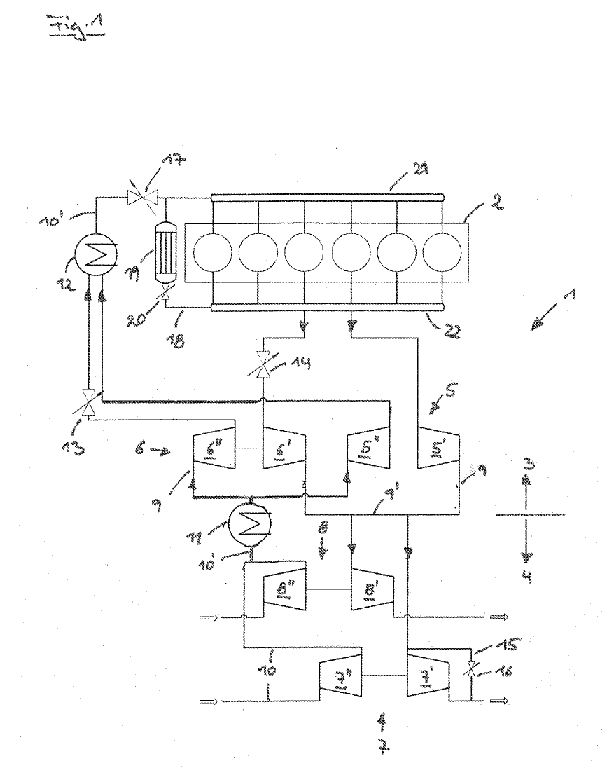

FIG. 1 shows schematically the construction of an inventive two-stage exhaust gas turbocharging device 1 for an internal combustion engine 2. In the internal combustion engine 2, six cylinders are for example schematically represented in series by six unnumbered circles, which on the inlet side are connected to an air manifold 21 and on the outlet side to an exhaust manifold 22 in a gas-conducting manner. The two-stage exhaust gas turbocharging device 1 substantially consists of a high-pressure stage 3 or a low-pressure stage 4. The high-pressure stage 3 and the low-pressure stage 4 are shown schematically separated by arrows.

The high-pressure stage 3 and the low-pressure stage 4 are connected to one another in a gas-conducting manner via exhaust-gas lines 9 and fresh-air lines 10 and to the air manifold 21 and the exhaust manifold 22. The high-pressure stage 3 in the present exemplary embodiment comprises a first exhaust gas turbocharger 5 and a second exhaust gas turbocharger 6 which is arranged parallel to the first exhaust gas turbocharger 5, each of which consist of a high-pressure turbine 5′, 6′ and a high-pressure compressor 5″, 6″. Furthermore, the low-pressure stage 4 in this exemplary embodiment consists of a third exhaust gas turbocharger 7 and a fourth exhaust gas turbocharger 8 arranged parallel to the third exhaust gas turbocharger 7 each with a low-pressure turbine 7′, 8′ and a low-pressure compressor 7″, 8″.

During the operation of the internal combustion engine 2, an exhaust gas of the internal combustion engine 2, which is collected in the exhaust manifold 22 flows first through the high-pressure turbines 5′, 6′, and subsequently the low-pressure turbines 7′, 8′. Following this, the exhaust gas again leaves the low-pressure turbines 7′, 8′ through an exhaust pipe 9 in each case, an outflow direction is schematically shown by two arrows. The turbine wheels 5′, 6′, 7′, 8′ driven by the exhaust gas in turn drive the compressor wheels 5″, 6″, 7″, 8″ in the compressors, wherein fresh air is conveyed first through the low-pressure compressors 7″, 8″ and then through the high-pressure compressors of 5″, 6″ in the direction of the internal combustion engine 2. Before the fresh air is conveyed into the internal combustion engine 2 it is still collected in the air manifold 21.

The two-stage exhaust gas turbocharging device 1 for an internal combustion engine 2 according to the invention is characterized in that the high-pressure turbines 5′, 6′ are connected to the low-pressure turbines 7′, 8′ at least in sections via a common exhaust-gas line 9′ and the low-pressure compressors 7″, 8″ are connected to the high-pressure compressors 5″, 6″ at least in sections via a common fresh-air line 10′.

Furthermore, in this exemplary embodiment, between the low-pressure compressors 7″, 8″ and the high-pressure compressors 5″, 6″ a first charge air cooler 11 that is common for the low-pressure compressors 7″, 8″ is arranged in the common fresh-air line 10′. Through this arrangement, an extremely compact construction of the exhaust gas turbocharging device 1 is achieved with simultaneously favorable manufacturing costs.

Furthermore, in this exemplary embodiment between the high-pressure compressors 5″, 6″ and the internal combustion engine 2 a second charge air cooler 12 that is likewise common for the high-pressure compressors 5″, 6″ is arranged in the common fresh-air line 10′. With this common arrangement, an extremely compact construction is likewise achieved with further reduced manufacturing costs.

Furthermore, between the high-pressure compressor 6″ and the second charge air cooler 12 a first throttle element 13 is arranged in the fresh-air line 10. With this first throttle element 13, a fine adjustment of the air mass flows through the two high-pressure compressors 5″, 6″ is possible. In another exemplary embodiment, the first throttle element 13 can also be arranged between the high-pressure compressor 5″ and the second charge air cooler 12.

Furthermore, between the internal combustion engine 2 and the high-pressure turbine 6′ a second throttle element 14 is arranged in the exhaust-gas line 9, in order to adjust the mass flow of exhaust gas through the high-pressure turbines 5′, 6′ depending on the operating state of the internal combustion engine. In a further exemplary embodiment, the throttle element 14 can also be arranged between the internal combustion engine 2 and the high-pressure turbine 5′.

Furthermore, the low-pressure turbine 7′ comprises a bypass 15, in which a third throttle element 16 is arranged. This bypass serves in order to blow off excess exhaust gas in order to avoid over-revving of the turbine wheel. In other exemplary embodiments, the high-pressure turbines 5′, 6′ and/or the low-pressure turbine 8′ can also comprise a bypass, in each of which in turn a further throttle element can be arranged.

Furthermore, the low-pressure compressor 7″ can comprise a bypass which is not shown, in which a throttle element is arranged. This bypass serves in order to blow off excess air in order to avoid over-revving of the compressor wheel. In other exemplary embodiments, the high-pressure compressors 5″, 6″ and/or the low-pressure compressor 8″ can also comprise a bypass in each of which in turn a further throttle element can be arranged.

Additionally, at least one high-pressure turbine 5′, 6′ and/or one low-pressure turbine 7′, 8′ can comprise a variable turbine geometry. With the help of this variable turbine geometry, essential efficiency increases of the exhaust gas turbocharging device 1 are once again possible.

Furthermore, the exhaust manifold 22 and the air manifold 21 are connected to one another in this exemplary embodiment via an exhaust gas recirculation line (EGR-line) 18, in order to realize an exhaust gas recirculation in this constellation. For cooling the exhaust gases, an exhaust gas recirculation cooler (EGR-cooler) 19 is provided, furthermore, in the exhaust gas recirculation line 18, as well as a fifth throttle element 20, with which the EGR-mass flow can be adjusted.

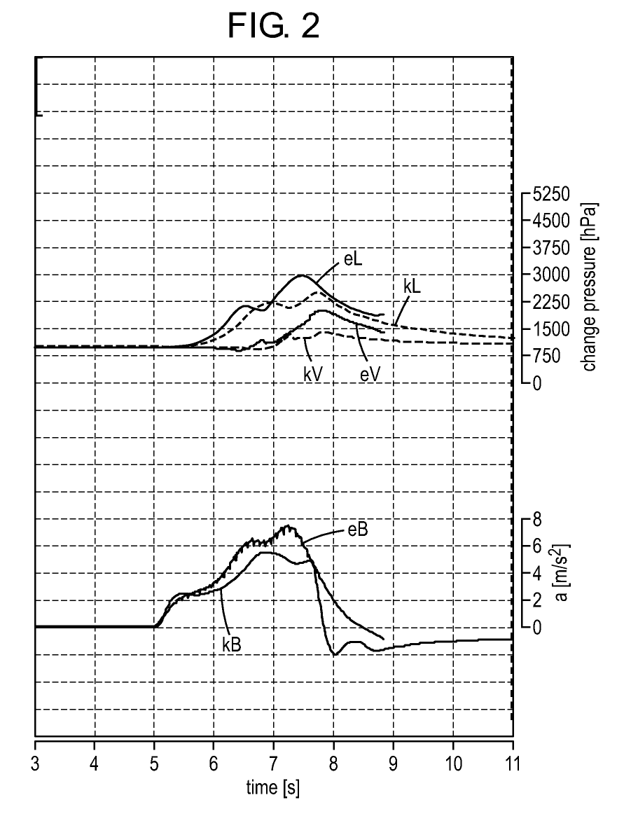

FIG. 2 shows in a diagram the comparison of a conventional two-stage exhaust gas turbocharging device for an internal combustion engine and a two-stage exhaust gas turbocharging device 1 for an internal combustion engine according to the invention.

By way of a Y-axis, a charge pressure [hPa] of 0 to 5,250 and a vehicle acceleration a [m/s2] of 0 to 8 are plotted. On an X-axis, the time [s] of 3 to 11 seconds is plotted.

A conventional pre-charge pressure kV and a conventional charge pressure kL are shown in interrupted lines, a pre-charge pressure eV according to the invention and a charge pressure eL according to the invention are shown as continuous lines. It is clearly evident that with the configuration according to the invention a substantially higher pre-charge pressure and a higher charge pressure can be created, which results in a significantly greater acceleration of a motor vehicle.

This is shown below in the diagram. An acceleration with conventional multi-stage turbocharging is marked with kB, an acceleration with multi-stage turbocharging according to the invention is marked with eB.

By splitting the one low-pressure stage 4 as described in DE 10 2006 011 188 A1 into two low-pressure stages or two low-pressure exhaust gas turbochargers 7, 8 which are arranged parallel next to one another and which are not combined in exhaust gas turbocharger groups as described in DE 36 07 698 C1, the dynamic run-up behavior and thus the acceleration capability of a motor vehicle can be significantly improved. The dynamic run-up behavior of the low-pressure exhaust gas turbochargers 7, 8 can be significantly improved through lower or divided mass moments of inertia of the running gear. The acceleration capability from the stationary state and in low gears is substantially improved.

### LIST OF REFERENCE NUMBERS

1 Turbocharging device
2 Internal combustion engine
3 High-pressure stage
4 Low-pressure stage
5 First exhaust gas turbocharger
5′ High-pressure turbine
5″ High-pressure compressor
6 Second exhaust gas turbocharger
6′ High-pressure turbine
6″ High-pressure compressor
7 Third exhaust gas turbocharger
7′ Low-pressure turbine
7″ Low-pressure compressor
8 Fourth exhaust gas turbocharger
8′ Low-pressure turbine
8″ Low-pressure compressor
9 Exhaust-gas line
9′ Common exhaust-gas line
10 Fresh-air line
10′ Common fresh-air line
11 First charge air cooler
12 Second charge air cooler
13 First throttle element
14 Second throttle element
15 Bypass
16 Third throttle element
17 Fourth throttle element
18 Exhaust gas recirculation line (EGR-line)
19 EGR-cooler
20 Fifth throttle element
21 Air manifold
22 Exhaust manifold

The foregoing disclosure has been set forth merely to illustrate the embodiments of the invention and is not intended to be limiting. Since modifications of the disclosed embodiments incorporating the spirit and substance of the embodiments of the invention may occur to persons skilled in the art, the embodiments of the invention should be construed to include everything within the scope of the appended claims and equivalents thereof.

What is claimed is:

1. A two-stage exhaust gas turbocharging device for an internal combustion engine, comprising:
a high-pressure stage; and
a low-pressure stage, the high-pressure stage and the low-pressure stage being connected via exhaust-gas lines and fresh-air lines in a gas-conducting manner, wherein
the high-pressure stage consists of at least one first exhaust gas turbocharger and a second exhaust gas turbocharger which is arranged parallel to the first each with a high-pressure turbine and a high-pressure compressor and the low-pressure stage consists of at least one third exhaust gas turbocharger and a fourth exhaust gas turbocharger arranged parallel to the third each with a low-pressure turbine and a low-pressure compressor, wherein an exhaust gas of the internal combustion engine can flow first through the high-pressure turbines and then the low-pressure turbines and wherein fresh air are conveyable first through the low-pressure compressors and then through the high-pressure compressors in the direction of the internal combustion engine, wherein the high-pressure turbines are connected to the low-pressure turbines at least in sections via a common exhaust-gas line and the low-pressure compressors to the high-pressure compressors at least in sections via a common fresh-air line.

2. The turbocharging device as claimed in claim 1, wherein the between the low-pressure compressors and the high-pressure compressors a first charge air cooler that is common for the low-pressure compressors is arranged in the fresh-air line.

3. The turbocharging device as claimed in claim 2, wherein between the high-pressure compressors and the internal combustion engine a second charge air cooler that is common for the high-pressure compressors is arranged in the fresh-air line.

4. The turbocharging device as claimed in claim 3, wherein between a high-pressure compressor and the second charge air cooler a first throttle element is arranged in the fresh-air line.

5. The turbocharging device as claimed in claim 4, wherein between the internal combustion engine and a high-pressure turbine a second throttle element is arranged in the exhaust-gas line.

6. The turbocharging device as claimed in claim 5, wherein at least one high-pressure turbine and/or one low-pressure turbine comprises a bypass.

7. The turbocharging device as claimed in claim 6, wherein in the bypass a third throttle element is arranged.

8. The turbocharging device as claimed in claim 7, wherein at least one high-pressure turbine and/or one low-pressure turbine has a variable turbine geometry.

9. The turbocharging device as claimed in claim 8, wherein one of the exhaust gas turbochargers is activatable and deactivatable.

10. The turbocharging device as claimed in claim 9, wherein at least one high-pressure compressor and/or one low-pressure compressor comprises a bypass.

11. The turbocharging device as claimed in claim 10, wherein in the bypass a throttle element is arranged.
